(19) United States
(12) Patent Application Publication
(10) Pub. No.: US 2026/0279974 A1
(43) Pub. Date: Sep. 17, 2026

(54) AIR SECONDARY BATTERY

(71) Applicant: FDK CORPORATION, Tokyo (JP)

(72) Inventors: Minori NISHI, Tokyo (JP); Takeshi KAJIWARA, Tokyo (JP); Shohei UNOKI, Tokyo (JP); Takahiro ENDO, Tokyo (JP); Shigekazu YASUOKA, Tokyo (JP)

(73) Assignee: FDK CORPORATION, Tokyo (JP)

(21) Appl. No.: 19/161,859

(22) PCT Filed: Mar. 6, 2024
(86) PCT No.: PCT/JP2024/008596

§ 371 Date: Sep. 3, 2025

(30) Foreign Application Priority Data
Mar. 15, 2023 (JP) 2023-041058

(51) Int. Cl. H01M 12/08; H01M 4/90; H01M 50/44; H01M 50/454; H01M 50/491

(52) U.S. Cl. CPC H01M 12/08; H01M 4/9016; H01M 50/44; H01M 50/454; H01M 50/491

(57) ABSTRACT

A battery includes a container, and an electrode group housed in the container together with an alkaline electrolyte solution, the electrode group includes an air electrode and a negative electrode stacked with a separator interposed therebetween, the air electrode 1 includes a core and an air electrode mixture, the air electrode mixture contains an oxygen catalyst and a manganese compound, and the separator is a composite formed by laminating a microporous membrane and a nonwoven fabric in a thickness direction.

### TECHNICAL FIELD

The present invention relates to an air secondary battery.

### BACKGROUND ART

In recent years, air batteries using oxygen in the air as a positive electrode active material have attracted attention because of their high energy density, ease of reduction in size and weight, and the like. Among such air batteries, zinc-air primary batteries have been commercialized as a power source for hearing aids.

In addition, as a chargeable air battery, an air secondary battery using Li, Zn, Al, Mg, or the like as a negative electrode metal has been studied, and such an air secondary battery is expected to become a new secondary battery that may have an energy density exceeding that of a lithium ion secondary battery.

As one type of such an air secondary battery, an air hydrogen secondary battery using an alkaline aqueous solution (hereinafter, also referred to as an alkaline electrolyte solution) as an electrolyte solution and using hydrogen as a negative electrode active material is known (for example, see Patent Literature 1). In the air hydrogen secondary battery represented by Patent Literature 1, a hydrogen storage alloy is used as a negative electrode metal, but since the negative electrode active material in the air hydrogen secondary battery is hydrogen to be absorbed in and released from the hydrogen storage alloy, a dissolution and precipitation reaction of the hydrogen storage alloy itself does not occur due to a chemical reaction during charging and discharging in the battery (hereinafter, also referred to as a battery reaction). Therefore, the air hydrogen secondary battery has an advantage that the air hydrogen secondary battery is free from problems such as occurrence of an internal short circuit caused by so-called dendrite growth in which the negative electrode metal precipitates in a dendritic form and a decrease in battery capacity caused by a shape change do not occur.

In an air secondary battery that uses an alkaline electrolyte solution, such as the air hydrogen secondary battery described above, a charge and discharge reaction represented below occurs in a positive electrode (hereinafter, also referred to as an air electrode).

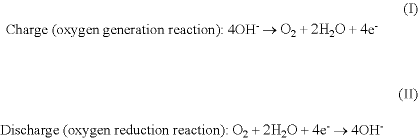

As represented in the reaction formula (I), in the air secondary battery, oxygen is generated at the air electrode during charging. This oxygen passes through voids inside the air electrode and is released into the air from a portion of the air electrode that is open to the air. Meanwhile, during discharging, oxygen taken in from the air is reduced to generate hydroxide ions, as represented in the reaction formula (II).

The reactions at the air electrode represented by the above reaction formulas (I) and (II) each have a relatively high overvoltage. In an air secondary battery, in order to improve energy efficiency and increase output, it is desired to reduce the overvoltage in a charge and discharge reaction of an air electrode. For the air electrode, which is the positive electrode of the air secondary battery described above, a catalyst having excellent activity for both oxygen generation and oxygen reduction is required in order to promote the charge and discharge reaction described above. Therefore, with regard to a material to be used as the catalyst in the air electrode, materials effective in reducing the overvoltage have been studied. As such materials effective in reducing the overvoltage, various metal oxides are promising. Among such metal oxides, a pyrochlore-type bismuth ruthenium oxide is considered to be particularly effective as a catalyst for an air electrode because the pyrochlore-type bismuth ruthenium oxide can reduce overvoltage in both charge and discharge reactions, has a wide and stable potential window, and has a “dual function” of oxygen reduction and oxygen generation having high charge and discharge cycle resistance.

The bismuth ruthenium oxide is produced, for example, by a production method of producing a precursor by a coprecipitation method using bismuth nitrate and ruthenium chloride as starting materials, and then calcining the precursor.

In producing the bismuth ruthenium oxide described above, by-products are formed in a process thereof. When an air electrode is produced using a catalyst containing the by-products and an air hydrogen secondary battery equipped with this air electrode is charged and discharged, the bismuth ruthenium oxide itself does not cause a dissolution and precipitation reaction, but bismuth and ruthenium derived from the by-products described above are eluted and dissolved in the alkaline electrolyte solution. Of the bismuth and ruthenium dissolved in the alkaline electrolyte solution, bismuth and ruthenium present near a negative electrode are precipitated on a surface of the negative electrode due to a negative electrode potential. As chemical reactions occur during charging and discharging in the battery, the dissolution and precipitation reactions of metal components (such as bismuth and ruthenium) derived from the by-products are repeated, and a so-called dendrite growth occurs, in which the metal components precipitate in a dendritic form on the negative electrode. When the metal components thus dendritically grow, the metal component extends into the separator and eventually penetrates the separator to reach the positive electrode. As a result, a problem occurs in that an internal short circuit occurs. When an internal short circuit thus occurs, not only ionic conductivity via the electrolyte but also electronic conductivity exists between the positive electrode and the negative electrode inside the battery. When electronic conductivity exists, the battery is self-discharging. The dendrite growth of the metal components increases in accordance with the number of charge-discharge cycles, and thus the self-discharge amount also increases as the charge-discharge cycle proceeds. As a result, the discharge capacity of the battery decreases with a relatively small number of cycles, the battery reaches an early end of life, and the cycle characteristics deteriorate.

In order to prevent such a decrease in cycle characteristics, a technique has been developed in which bismuth ruthenium oxide is subjected to an acid treatment to remove by-products generated during the production process, as disclosed in, for example, Patent Literature 2.

### CITATION LIST

### Patent Literature

Patent Literature 1: Japanese Patent No. 6444205
Patent Literature 2: JP2019-179592A

### SUMMARY OF INVENTION

### Technical Problem

When the acid treatment as described above is performed, the resulting bismuth ruthenium oxide particles tend to aggregate and form relatively large clumps. For this reason, the aggregated clumps of bismuth ruthenium oxide particles are disintegrated to a predetermined particle size. Such a disintegrating operation is performed using, for example, a bead mill apparatus.

The aggregated clumps of bismuth ruthenium oxide particles may contain by-products that are not removed by the acid treatment. If these clumps containing by-products are disintegrated, the by-products may become exposed on newly formed surfaces, and there is a risk that an internal short circuit will occur due to the influence of the exposed by-products. That is, since the acid treatment requires disintegrating as a follow-up step, there is a problem that the acid treatment alone cannot sufficiently prevent internal short circuits. Therefore, in the air secondary battery, the cycle characteristics are not sufficiently improved even when the acid treatment is performed.

The present invention has been made in view of the above circumstances, and an object of the present invention is to provide an air secondary battery that prevents an internal short circuit caused by dendrites resulting from by-products of an oxygen catalyst, thereby achieving excellent cycle life characteristics.

### Solution to Problem

In order to achieve the object, according to the present invention, there is provided an air secondary battery including: a container; and an electrode group housed in the container together with an alkaline electrolyte solution, in which the electrode group includes an air electrode and a negative electrode stacked with a separator interposed therebetween, the air electrode includes a core and an air electrode mixture, the air electrode mixture contains an oxygen catalyst and a manganese compound, and the separator is a composite formed by laminating a microporous membrane and a nonwoven fabric in a thickness direction.

### Advantageous Effects of Invention

The air secondary battery according to the present invention includes: a container; and an electrode group housed in the container together with an alkaline electrolyte solution, in which the electrode group includes an air electrode and a negative electrode stacked with a separator interposed therebetween, the air electrode includes a core and an air electrode mixture, the air electrode mixture contains an oxygen catalyst and a manganese compound, and the separator is a composite formed by laminating a microporous membrane and a nonwoven fabric in a thickness direction. With this structure, the extension of dendrites of metal components that are by-products of the oxygen catalyst is prevented in the microporous membrane, and further, the manganese compounds are eluted into the alkaline electrolyte solution and precipitated on an air electrode side of the microporous membrane of the separator to block the pores of the microporous membrane, so that the penetration of the dendrites of metal components that are by-products of the oxygen catalyst toward the air electrode side is effectively prevented. As a result, an internal short circuit is prevented and cycle life characteristics are improved.

### BRIEF DESCRIPTION OF DRAWINGS

FIG. 1 is a cross-sectional view schematically illustrating an air hydrogen secondary battery according to an embodiment.

FIG. 2 is a graph illustrating a relation between the number of charge-discharge cycles and a post-charging open circuit voltage (OCV), which is an OCV 10 minutes after the start of rest following charging.

FIG. 3 is a configuration diagram schematically illustrating analysis points where elemental analysis is performed on an air electrode side nonwoven fabric, a microporous membrane, and a negative electrode side nonwoven fabric constituting a separator positioned between an air electrode and a negative electrode.

FIG. 4 is a graph illustrating a distribution state of Mn, Ru, and Bi in Example 1 based on atomic percentages of Mn, Ru, and Bi at the analysis points illustrated in FIG. 3.

FIG. 5 is a graph illustrating a distribution state of Ru and Bi in Comparative Example 1 based on atomic percentages of Ru and Bi at the analysis points illustrated in FIG. 3.

### DESCRIPTION OF EMBODIMENTS

Hereinafter, an air hydrogen secondary battery (hereinafter, also referred to as a battery) 2 including an air electrode for an air secondary battery according to an embodiment will be described with reference to the drawings.

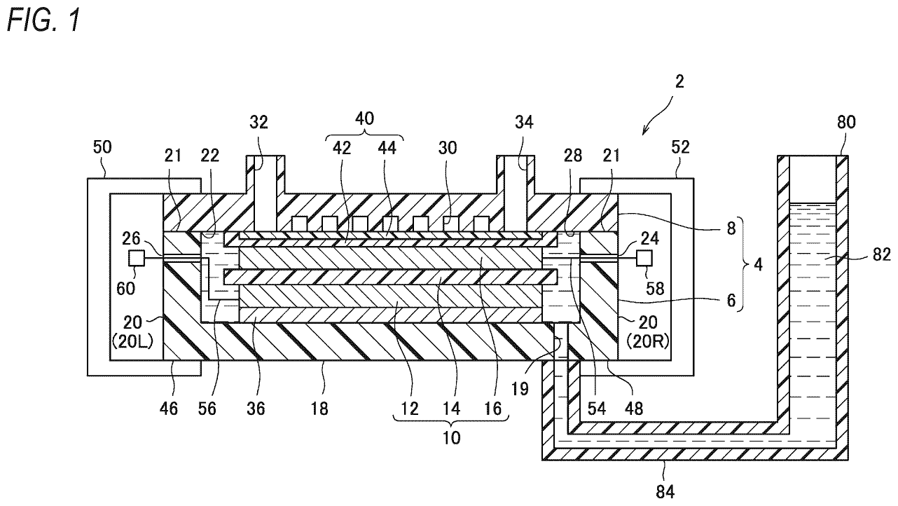

As illustrated in FIG. 1, the battery 2 includes a container 4 and an electrode group 10 housed in the container 4 together with an alkaline electrolyte solution 82.

The electrode group 10 is formed by stacking a negative electrode 12 and an air electrode (positive electrode) 16 with a separator 14 interposed therebetween.

The negative electrode 12 includes a conductive negative electrode core that forms a porous structure and has a large number of pores, and a negative electrode mixture supported inside the pores and on a surface of the negative electrode core. As the negative electrode core, foamed nickel may be used, for example.

The negative electrode mixture contains a hydrogen storage alloy powder, which is an aggregate of hydrogen storage alloy particles capable of absorbing and releasing hydrogen serving as a negative electrode active material, a conductive material, and a binder. Here, as the conductive material, a graphite powder, a carbon black powder, or the like may be used.

The hydrogen storage alloy constituting the hydrogen storage alloy particles is not particularly limited, and for example, a rare earth-Mg—Ni-based hydrogen storage alloy is preferably used. The composition of the rare earth-Mg—Ni-based hydrogen storage alloy can be freely selected, and for example, it is preferable to use one represented by the general formula:

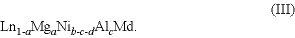

In the general formula (III), Ln represents at least one element selected from the group consisting of La, Ce, Pr. Nd, Pm, Sm, Eu, Gd, Tb, Dy, Ho, Er, Tm, Yb, Lu, Sc, Y, Zr, and Ti, M represents at least one element selected from the group consisting of V, Nb, Ta, Cr, Mo, Mn, Fe, Co, Ga, Zn, Sn, In, Cu, Si, P, and B, and the subscripts a, b, c, and d represent numbers satisfying the following relations, respectively: 0.01≤a≤0.30, 2.8≤b≤3.9, 0.05≤c≤0.30, and 0≤d≤0.50.

Here, the hydrogen storage alloy particles are obtained as follows, for example.

First, metal raw materials are weighed and mixed to achieve a predetermined composition, and the mixture is dissolved in, for example, a high-frequency induction melting furnace in an inert gas atmosphere, and then cooled to form an ingot. The obtained ingot is heated to 900° C. to 1200° C. in an inert gas atmosphere, and kept at this temperature for 5 hours to 24 hours to perform a heat treatment, and thus homogenized. Thereafter, the ingot is pulverized and sieved to obtain a hydrogen storage alloy powder which is an aggregate of hydrogen storage alloy particles having a desired particle size.

Examples of the binder include sodium polyphosphate, carboxymethyl cellulose, and styrene butadiene rubber.

Here, the negative electrode 12 may be produced as follows, for example.

First, the hydrogen storage alloy powder, which is an aggregate of hydrogen storage alloy particles, the conductive material, the binder, and water are kneaded to prepare a negative electrode mixture paste. The obtained negative electrode mixture paste is filled in the negative electrode core, and then subjected to a drying treatment. After drying, the negative electrode core to which the hydrogen storage alloy particles and the like are attached is rolled and pressed to increase the alloy content per unit volume, and then cut, thereby obtaining the negative electrode 12. The negative electrode 12 has a plate-like shape as a whole. The negative electrode mixture layer included in the negative electrode 12 is formed of hydrogen storage alloy particles, conductive material particles, and the like, and thus there are voids between the particles, and the negative electrode mixture layer has a porous structure as a whole.

Next, the air electrode 16 includes a conductive air electrode core, and an air electrode mixture layer (positive electrode mixture layer) formed of an air electrode mixture (positive electrode mixture) held by the air electrode core.

As the air electrode core as described above, a metal porous body may be used. As the metal porous body, a foamed metal is preferably used. As the foamed metal, foamed nickel is preferably used. As the metal porous body, a nickel mesh or a nickel sintered body obtained by sintering a nickel powder may also be used.

The air electrode mixture contains an oxygen catalyst, a conductive material, a water repellent, and a manganese compound. Further, a viscosity modifier is preferably added to the air electrode mixture.

As the oxygen catalyst, one having a dual function of oxidation-reduction is used. Such a catalyst having a dual function contributes to reducing an overvoltage of the battery in both the charging process and the discharging process. As such an oxygen catalyst, for example, a pyrochlore-type bismuth ruthenium oxide is preferably used. The bismuth ruthenium oxide has a dual function of oxygen generation and oxygen reduction.

The bismuth ruthenium oxide has a pyrochlore-type crystal structure represented by a composition formula of Bi₂₋ₓRu₂O_{7-z} (where 0≤x≤1, and z satisfies a relation of 0≤z≤1).

The pyrochlore-type bismuth ruthenium oxide as described above may be produced, for example, as follows.

Bi(NO₃)₃·5H₂O and RuCl·₃H₂O are prepared. Then, Bi(NO₃)₃·5H₂O and RuCl_{3·3}H₂O are weighed so that the molar ratio of Ru is 1.00 and the molar ratio of Bi is 0.50 or more and less than 0.80. The weighed Bi(NO₃)₃·5H₂O and RuCl₃·3H₂O are put into a predetermined solution and stirred to prepare a mixed aqueous solution of Bi(NO₃)₃·5H₂O and RuCl₃·3H₂O. At this time, examples of the predetermined solution include distilled water and a dilute nitric acid aqueous solution, and the temperature of the solution is 60° C. or higher and 90° C. or lower. Then, a NaOH aqueous solution with a concentration of 1 mol/L or more and 3 mol/L or less is added to the mixed aqueous solution to precipitate a precursor (coprecipitation step). After the precursor is precipitated, the mixed aqueous solution is stirred. The stirring operation is performed for 12 hours to 60 hours with oxygen bubbling. During the stirring operation, the pH of the mixed aqueous solution is maintained at 10 to 12, and the temperature is maintained at 60° C. or higher and 90° C. or lower. After the stirring operation is completed, the mixed aqueous solution is left to stand for 12 hours to 60 hours. Following this standing period, the resulting precipitate is collected by suction filtration. The collected precipitate is kept at 80° C. or higher and 100° C. or lower to evaporate a part of the moisture to form a paste. This paste is transferred to an evaporating dish, heated to 100° C. or higher and 150° C. or lower, and dried by being kept in that state for 1 hour or more and 5 hours or less to obtain a dried paste. The obtained dried paste is put in a mortar, and ground and pulverized with a pestle to obtain a precursor powder.

Next, the precursor powder is subjected to a heat treatment by being heated to a temperature of 400° C. or higher and 700° C. or lower in an air atmosphere and kept for 0.5 hours or more and 4 hours or less (calcination step). The heat-treated powder is washed with distilled water at 60° C. or higher and 90° C. or lower, and then subjected to a drying treatment. The drying treatment is performed by holding the washed powder at 60° C. or higher and 130° C. or lower for 1 hour or more and 12 hours or less. Thus, pyrochlore-type bismuth ruthenium oxide (Bi₂₋ₓRu₂O_{7-z}) is obtained.

Next, the obtained bismuth ruthenium oxide is preferably immersed in a nitric acid aqueous solution to perform an acid treatment. The acid treatment is specifically as follows.

First, a nitric acid aqueous solution is prepared. Here, the concentration of the nitric acid aqueous solution is preferably 5 mol/L or less. The amount of the nitric acid aqueous solution is preferably prepared at a ratio of 20 mL per 1 g of the bismuth ruthenium oxide. The temperature of the nitric acid aqueous solution is preferably set to 20° C. or higher and 25° C. or lower.

Then, the bismuth ruthenium oxide is immersed in the prepared nitric acid aqueous solution and stirred for 1 hour or more and 6 hours or less. After stirring for a predetermined time, the bismuth ruthenium oxide is separated from the nitric acid aqueous solution by suction filtration. The filtered bismuth ruthenium oxide is put in distilled water set at 60° C. or higher and 80° C. or lower, and washed.

The washed bismuth ruthenium oxide is kept at 60° C. or higher and 130° C. or lower for 1 hour or more and 12 hours or less to perform a drying treatment.

In this manner, the bismuth ruthenium oxide subjected to the acid treatment is obtained. By performing the acid treatment in this manner, by-products generated in the calcination step of the bismuth ruthenium oxide can be removed. The acidic aqueous solution used in the acid treatment is not limited to the nitric acid aqueous solution, and a hydrochloric acid aqueous solution and a sulfuric acid aqueous solution may be used in addition to the nitric acid aqueous solution. The hydrochloric acid aqueous solution and the sulfuric acid aqueous solution also have the effect of removing by-products, similar to the nitric acid aqueous solution.

In the acid treatment process as described above, fine particles of the bismuth ruthenium oxide aggregate to form relatively large clumps. For this reason, in order to obtain bismuth ruthenium oxide particles having a predetermined particle size, it is necessary to disintegrate the aggregated clumps of the bismuth ruthenium oxide.

The disintegration method is not particularly limited, but for example, it is preferable to use a wet bead mill apparatus for a disintegration treatment. As a procedure in the case of performing the disintegration treatment using the wet bead mill apparatus, first, ion-exchanged water and a dispersant are added to the bismuth ruthenium oxide subjected to the acid treatment, and the mixture is stirred to prepare a dispersion. Next, the dispersion is fed into a disintegration chamber of the wet bead mill apparatus at a predetermined flow rate using a pump. Zirconia beads having a predetermined diameter, for example, a diameter of 0.1 mm, are placed in the disintegration chamber. Then, a centrifugal force generated by driving a stirring mechanism in the disintegration chamber at a predetermined speed causes the energized beads to act on the clumps of the bismuth ruthenium oxide particles to be disintegrated. Thus, the clumps of the bismuth ruthenium oxide particles are disintegrated. The dispersion subjected to the disintegration treatment is rejected from the disintegration chamber. Here, in the wet bead mill apparatus, the dispersion rejected from the disintegration chamber is fed again into the disintegration chamber and subjected to the disintegration treatment again. In this way, by setting the procedure of performing the liquid feeding, the disintegration treatment, and the rejection on the dispersion as one pass and repeating the procedure of one pass several times, the clumps of the bismuth ruthenium oxide particles can be more finely disintegrated.

As described above, when the bismuth ruthenium oxide is subjected to the acid treatment, it is necessary to perform the disintegration treatment in combination. Here, most of the by-products are removed by subjecting the bismuth ruthenium oxide subjected to the calcination step to the acid treatment. However, when the bismuth ruthenium oxide particles aggregate to form clumps during the acid treatment, the by-products may be incorporated into the clumps without being removed. The by-products incorporated into the clumps of the bismuth ruthenium oxide remain as they are, but may be exposed from a new surface formed by the disintegration treatment after the acid treatment. Although the amount of the by-products thus exposed is small, the by-products are repeatedly dissolved and precipitated during the charge and discharge reaction of the battery, forming dendrites that may cause internal short circuits. That is, it is difficult to completely remove the by-products only by the acid treatment, and the by-products are exposed by the disintegration treatment, so that the internal short circuit cannot be sufficiently prevented. Therefore, in the present embodiment, most of the by-products are removed by performing the acid treatment, thereby preventing the occurrence of almost all internal short circuits, and further, the occurrence of internal short circuits caused by the unavoidable small amount of remaining by-products is prevented by using a manganese compound described below and a separator including a microporous membrane.

Next, the conductive material will be described. The conductive material is used to reduce an internal resistance in order to increase the output of the air secondary battery. Further, the conductive material is also used as a carrier for supporting the oxygen catalyst.

As such a conductive material (catalyst-supporting conductive material), for example, graphite or nickel is used. In particular, a graphite powder made of graphite particles is preferably used. An average particle size of the graphite particles is not particularly limited, and is preferably a size capable of imparting desired conductivity to the air electrode.

As the graphite powder in the present embodiment, it is preferable to use a graphite powder having an average particle size (median diameter, hereinafter, also referred to as D50) of graphite particles measured by a laser diffraction/scattering type particle size distribution measuring device of 1 μm or more and 5 μm or less.

The conductive material is preferably contained in an amount of 20 wt % or more in the air electrode mixture. An upper limit of the content of the conductive material is preferably 50 wt % or less in relation to other constituent materials in the air electrode mixture.

The water repellent imparts appropriate water repellency to the air electrode 16. Here, a fluororesin is used as the water repellent. Examples of the fluororesin include perfluoroethylene propene copolymer (FEP), polytetrafluoroethylene (PTFE), perfluoroalkoxy alkane polymer (PFA), ethylene-tetrafluoroethylene copolymer (ETFE), polyvinylidene fluoride (PVDF), and polyvinyl fluoride (PVF). Here, FEP is preferably used from a viewpoint of excellent stability with respect to a charge and discharge reaction.

The fluororesin is preferably contained in an amount of 19.8 wt % or more in the air electrode mixture. When the content of the fluororesin exceeds 40 wt %, the content of the oxygen catalyst that contributes to the charge and discharge reaction is relatively reduced, resulting in deterioration of battery characteristics, and thus an upper limit of the content of the fluororesin in the air electrode mixture is preferably 40 w1%.

Here, a binder may be added to the air electrode mixture as necessary. However, a part of the fluororesin also functions to bind other constituent materials of the air electrode mixture, and thus can also serve as the binder. When a fluororesin that also functions to bind other constituent materials is used as described above, there is no need to add a separate binder.

The viscosity modifier functions to adjust a viscosity of an air electrode mixture slurry described below when preparing the air electrode mixture slurry. As the viscosity modifier, hydroxypropyl cellulose (HPC) is preferably used.

As the manganese compound, for example, manganese dioxide is preferably used. In the present embodiment, it is preferable to use a manganese dioxide powder, which is an aggregate of manganese dioxide particles. As the manganese dioxide powder, it is preferable to use a manganese dioxide powder having an average particle size (median diameter, hereinafter, also referred to as D50) of manganese dioxide particles measured by a laser diffraction/scattering type particle size distribution measuring device of 1 μm or more and 10 μm or less. The manganese dioxide is preferably used after being subjected to a calcination treatment by being heated to 400° C. or higher and 500° C. or lower in an air atmosphere and kept for 5 hours or more and 10 hours or less.

Mn is eluted from the manganese compound into the electrolyte solution, and the eluted Mn precipitates on the microporous membrane included in the separator to block the pores of the microporous membrane to some extent. Accordingly, penetration of dendrites derived from the by-products of the bismuth ruthenium oxide is prevented. The manganese compound is preferably added in an amount of 5 wt % or more with respect to the bismuth ruthenium oxide. This is because, when the addition amount of the manganese compound is less than 5 wt % with respect to the bismuth ruthenium oxide, the effect of preventing the penetration of the dendrites cannot be sufficiently exhibited. Meanwhile, when the addition amount of the manganese compound exceeds 150 wt % with respect to the bismuth ruthenium oxide, a large amount of Mn eluted from an excessive amount of the manganese compound precipitates, and there is a possibility that the pores of the microporous membrane are completely blocked and the battery reaction is inhibited, and thus an upper limit value of the addition amount of the manganese compound is preferably 150 wt % or less with respect to the bismuth ruthenium oxide.

The air electrode 16 can be produced, for example, as follows.

First, the catalyst powder which is an aggregate of bismuth ruthenium oxide particles, a conductive material powder which is an aggregate of carbon material particles as a conductive material, the water repellent, the viscosity modifier, the manganese dioxide powder, and water are prepared. Then, the catalyst powder, the conductive material powder, the water repellent, the viscosity modifier, the manganese dioxide powder, and water are kneaded to prepare the air electrode mixture slurry.

Meanwhile, a metal porous body sheet is prepared as the air electrode core. The prepared metal porous body sheet is rolled and pressed in advance to adjust to a predetermined thickness. The air electrode mixture slurry obtained as described above is then filled into the metal porous body sheet. The air electrode mixture slurry is filled and held inside the pores in the metal porous body, and is also held on the surface of the metal porous body. The air electrode core holding the air electrode mixture slurry is kept in an atmosphere of 50° C. or higher and 80° C. or lower for 10 minutes or more and 2 hours or less to perform a drying treatment. After the drying treatment, the moisture of the air electrode mixture slurry evaporates, leaving the air electrode core holding the air electrode mixture. Thereafter, the air electrode core holding the air electrode mixture is subjected to a roll pressing treatment. After the roll pressing treatment, the air electrode core holding the air electrode mixture is cut into a predetermined shape, thereby obtaining the air electrode 16.

Next, the obtained air electrode 16 is put into a heat treatment furnace to perform a heat treatment (calcination treatment). The calcination treatment is preferably performed in an inert gas atmosphere in production, but the calcination treatment may be performed in an air atmosphere. As the inert gas, for example, nitrogen gas or argon gas is used. The calcination treatment conditions include heating to a temperature of 200° C. or higher and 400° C. or lower, and maintaining this state for 10 minutes or more and 40 minutes or less. Thereafter, the air electrode 16 is naturally cooled in the heat treatment furnace, and is taken out into the air when the temperature of the air electrode 16 becomes 150° C. or lower. Thus, the air electrode 16 subjected to the calcination treatment is obtained. The air electrode 16 includes an air electrode mixture layer formed of the air electrode mixture. The air electrode mixture layer formed of such an air electrode mixture has a porous structure including a large number of fine pores as a whole. As for the air electrode 16, the air electrode 16 may be formed by subjecting the air electrode core holding the air electrode mixture to the roll pressing treatment, followed by the calcination treatment, and then cutting into a predetermined shape.

The air electrode 16 and the negative electrode 12 obtained as described above are stacked with the separator 14 interposed therebetween, thereby forming the electrode group 10.

The separator 14 is disposed to avoid short circuits between the air electrode 16 and the negative electrode 12, and is made of an electrically insulating material. The separator 14 is a composite in which the microporous membrane and the nonwoven fabric are laminated in the thickness direction. Preferably, the composite has a two-layer structure in which one sheet of the microporous membrane and one sheet of the nonwoven fabric are stacked. More preferably, the composite has a three-layer structure in which one sheet of the microporous membrane is sandwiched between two sheets of the nonwoven fabrics.

The microporous membrane generally refers to a polymer film having a large number of pores with an average pore size of 0.1 μm or less. As the microporous membrane, a microporous membrane separator made of polyolefin for a lithium ion battery is known, and in the present embodiment, the microporous membrane separator for a lithium ion battery may be used. However, since an alkaline aqueous solution is used as an electrolyte solution in air secondary batteries, it is preferable to subject the microporous membrane to a hydrophilic treatment. Examples of the hydrophilic treatment include a plasma treatment for imparting a polar functional group to a surface by surface modification using oxygen radicals, a sulfonation treatment for producing a sulfone group on the surface by a treatment in sulfur trioxide gas or fuming sulfuric acid, and a treatment using a surfactant. In the present embodiment, it is preferable to select a hydrophilic treatment using a surfactant as the hydrophilic treatment in order to prevent damage to the microporous membrane.

In addition, in lithium ion batteries, a microporous membrane made of polyethylene having a melting point of 130° C. to 140° C. is mainly used in order to enhance safety. This is intended to provide a shutdown function when the battery temperature abnormally rises due to a short circuit or the like, in which the polyethylene that makes up the microporous membrane melts to block the pores and stop the passage of ions through the separator. However, since an alkaline aqueous solution is used in the air secondary battery, a microporous membrane made of polypropylene having a low risk of combustion and a higher melting point may be used. In the present embodiment, a microporous membrane made of polyethylene may also be used.

In addition, in lithium-ion batteries, it is common to use a microporous membrane alone as the separator. However, in air secondary batteries, the electrolyte solution replenishment property of the separator is important, and thus a composite obtained by combining a microporous membrane with a nonwoven fabric used as a separator in nickel hydrogen secondary batteries is used as the separator. Since the nonwoven fabric is characterized by having a higher porosity and an excellent electrolyte solution replenishment property as compared with the microporous membrane, it is suitable for complementing the electrolyte solution replenishment property of the microporous membrane.

The nonwoven fabric may be, for example, a nonwoven fabric made of polyamide fibers with hydrophilic functional groups imparted, or a nonwoven fabric made of polyolefin fibers such as polyethylene or polypropylene with hydrophilic functional groups imparted.

The formed electrode group 10 is put into the container 4. The container 4 is not particularly limited as long as it can house the electrode group 10 and the alkaline electrolyte solution, and for example, a box-shaped container 4 is used. The container 4 includes, for example, a container body 6 and a lid 8 as illustrated in FIG. 1. The material for the container 4 is not particularly limited as long as it can withstand the alkaline electrolyte solution, and examples thereof include an acrylic resin and a metal material.

The container body 6 has a box shape including a bottom wall 18 and side walls 20 extending upward from peripheral edge portions of the bottom wall 18. A portion surrounded by upper end edges 21 of the side walls 20 is open. That is, an opening 22 is provided on an opposite side of the bottom wall 18. In addition, the side walls 20 are provided with through holes at predetermined positions on a right side wall 20R and a left side wall 20L, respectively, and these through holes serve as withdrawal openings 24 and 26 of lead wires described below.

Further, an electrolyte solution storage portion 80 is attached to the container body 6. The electrolyte solution storage portion 80 is a container that houses the alkaline electrolyte solution 82 and is attached, for example, via a coupling portion 84 that communicates with a through hole 19 provided in the bottom wall 18. The coupling portion 84 is a flow path of the alkaline electrolyte solution 82 and communicates between the inside of the container 4 and the electrolyte solution storage portion 80. In this way, the inside of the container 4 and the electrolyte solution storage portion 80 communicate with each other, and thus the alkaline electrolyte solution 82 can flow between the inside of the container 4 and the electrolyte solution storage portion 80.

The lid 8 has the same shape as the container body 6 in plan view, and placed on the upper portion of the container body 6 to close the opening 22. The gap between the lid 8 and the upper end edge 21 of the side walls 20 is liquid-tightly sealed.

In the lid 8, a ventilation passage 30 is provided on an inner surface 28 facing the inside of the container body 6. The ventilation passage 30 has its portion facing the inside of the container body 6 open and has a single serpentine shape as a whole. Further, the lid 8 is provided with an inlet ventilation hole 32 and an outlet ventilation hole 34 at predetermined positions, both penetrating in the thickness direction. The inlet ventilation hole 32 communicates with one end of the ventilation passage 30, and the outlet ventilation hole 34 communicates with the other end of the ventilation passage 30. That is, the ventilation passage 30 is open to the air via the inlet ventilation hole 32 and the outlet ventilation hole 34. A pressure pump (not illustrated) is preferably attached to the inlet ventilation hole 32. By driving the pressure pump, air can be sent from the inlet ventilation hole 32 to the ventilation passage 30.

An adjustment member 36 is disposed on the bottom wall 18 of the container body 6 as necessary. The adjustment member 36 is used for positioning the electrode group 10 in a height direction in the container 4. As the adjustment member 36, for example, a foamed nickel sheet is used.

The electrode group 10 is disposed on the adjustment member 36. At this time, the negative electrode 12 of the electrode group 10 is disposed so as to be in contact with the adjustment member 36.

Meanwhile, a water-repellent ventilation member 40 is disposed on the air electrode 16 side of the electrode group 10 so as to be in contact with the air electrode 16. The water-repellent ventilation member 40 is formed by combining a nonwoven fabric diffusion sheet 44 with a PTFE porous membrane 42. The water-repellent ventilation member 40 exhibits a water-repellent effect by the PTFE and allows gas to pass therethrough. The water-repellent ventilation member 40 is interposed between the lid 8 and the air electrode 16 and is in close contact with both the lid 8 and the air electrode 16. The water-repellent ventilation member 40 is sized to cover the entirety of the ventilation passage 30, the inlet ventilation hole 32, and the outlet ventilation hole 34 of the lid 8.

The container body 6 housing the electrode group 10, the adjustment member 36, and the water-repellent ventilation member 40 as described above is covered with the lid 8. Then, as schematically illustrated in FIG. 1, peripheral edge portions 46 and 48 of the container 4 (the container body 6 and the lid 8) are sandwiched from above and below by coupling tools 50 and 52, respectively. Thereafter, a predetermined amount of the alkaline electrolyte solution 82 is injected from the electrolyte solution storage portion 80, and the alkaline electrolyte solution 82 is introduced into the container 4. The battery 2 is thus formed.

As the alkaline electrolyte solution 82 described above, a general alkaline electrolyte solution used for an alkaline secondary battery is suitably used, and specifically, an aqueous solution containing at least one of NaOH, KOH, and LiOH as a solute is used.

Here, in the battery 2, the ventilation passage 30 of the lid 8 faces the water-repellent ventilation member 40. Since the water-repellent ventilation member 40 allows gas to pass therethrough but blocks moisture, the air electrode 16 is open to the air via the water-repellent ventilation member 40, the ventilation passage 30, the inlet ventilation hole 32, and the outlet ventilation hole 34. That is, the air electrode 16 comes into contact with the air through the water-repellent ventilation member 40.

In the battery 2, an air electrode lead (positive electrode lead) 54 is electrically connected to the air electrode (positive electrode) 16, and a negative electrode lead 56 is electrically connected to the negative electrode 12. Although schematically illustrated in FIG. 1, the air electrode lead 54 and the negative electrode lead 56 are respectively drawn outside the container 4 from the withdrawal openings 24 and 26 while maintaining airtightness and liquid tightness. An air electrode terminal (positive electrode terminal) 58 is provided at a tip of the air electrode lead 54, and a negative electrode terminal 60 is provided at a tip of the negative electrode lead 56. Therefore, in the battery 2, the air electrode terminal 58 and the negative electrode terminal 60 are used to input and output current during charging and discharging.

### EXAMPLES

1. Production of Battery

### Example 1

(1) Synthesis of Oxygen Catalyst for Air Secondary Battery
1) Coprecipitation Step

Bi(NO₃)₃·5H₂O and RuCl₃·3H₂O were prepared. Then, Bi(NO₃)₃·5H₂O and RuCl₃·3H₂O were weighed so that the molar concentration ratio of Ru was 1.00 and the molar concentration of Bi was 0.75. The weighed Bi(NO₃)₃·5H₂O and RuCl₃·3H₂O were put into a dilute nitric acid aqueous solution at 75° C. and stirred to prepare a mixed aqueous solution of Bi(NO₃)₃·5H₂O and RuCl₃·3H₂O. Further, a NaOH aqueous solution with a concentration of 2 mol/L was prepared. Then, the mixed aqueous solution and the NaOH aqueous solution were simultaneously dropped into a glass reaction vessel having a volume of 300 mL. At this time, the dropping time was adjusted so that overflow occurred when the average residence time of the mixed aqueous solution and the NaOH aqueous solution in the reaction vessel reached 30 minutes. Here, the average residence time is defined as: average residence time=reaction vessel volume [mL]/dropping speed [mL/min], where dropping speed=dropping volume [mL]/dropping time [min]. That is, when a fixed volume of solution was dripped into a reaction vessel having a certain volume, the dropping time of the solution was adjusted so that the solution dropped at a predetermined dropping volume would overflow. Specifically, when the solution was dropped at a dropping speed that causes a reaction vessel having a volume of 300 mL to overflow after 30 minutes, the average residence time was 30 minutes.

The precursor was precipitated by reacting the mixed aqueous solution with the NaOH aqueous solution as described above. Thereafter, the overflowed mixed aqueous solution containing the precursor was put into a stirring vessel, and a stirring operation was performed. The stirring operation was performed for 24 hours while performing oxygen bubbling. During the stirring operation, the pH of the mixed aqueous solution was maintained at 10.7 and the temperature thereof was maintained at 70° C. After the stirring operation was completed, the mixed aqueous solution was left to stand for 24 hours. After being left to stand, the resulting precipitate was collected by filtration. The collected precipitate was kept at 85° C. to evaporate a part of the moisture to form a paste. The obtained paste was transferred to an evaporating dish, heated to 120° C., and kept in that state for 3 hours to perform a drying treatment, thereby to obtaining a dried precursor. The obtained dried precursor was put in a mortar, and ground and pulverized with a pestle to obtain a powder.

### 2) Calcination Step

The obtained precursor powder was heated to a calcination temperature of 500° C. in an air atmosphere and kept for 3 hours to perform a calcination treatment. After the calcination treatment was completed, the precursor powder was washed with distilled water at 70° C., then subjected to suction filtration, and then kept at 120° C. for 3 hours to perform a drying treatment. Thus, a pyrochlore-type bismuth ruthenium oxide (oxygen catalyst) was obtained.

### 3) Acid Treatment Step

A nitric acid aqueous solution was prepared in a proportion of 20 mL per 1 g of the bismuth ruthenium oxide powder. Then, the aqueous nitric acid solution and the bismuth ruthenium oxide powder were placed in a stirring tank of a stirrer and stirred for 1 hour while the temperature of the nitric acid aqueous solution was kept at 25° C. to perform an acid treatment. Here, the concentration of the nitric acid aqueous solution was 2 mol/L.

After the stirring was completed, the bismuth ruthenium oxide powder was removed from the nitric acid aqueous solution by suction filtration. The removed bismuth ruthenium oxide powder was washed with 1 liter of distilled water heated to 70° C. After washing, the bismuth ruthenium oxide powder was dried by being kept in an atmosphere at 120° C. for 3 hours. In this way, acid-treated bismuth ruthenium oxide powder, that is, oxygen catalyst powder for air secondary batteries, was obtained.

### 4) Disintegration Treatment Step

Since the bismuth ruthenium oxide powder subjected to the acid treatment step aggregate into relatively large clumps, a disintegration treatment is required. Ion-exchanged water was prepared in an amount such that the solid content ratio per weight of the bismuth ruthenium oxide powder subjected to the acid treatment step was 10 wt %, and a dispersant (ammonium polycarboxylate, manufactured by SAN NOPCO Ltd., SN Dispersant 5468) was prepared in an amount such that the solid content ratio per weight of the bismuth ruthenium oxide powder subjected to the acid treatment step was 1 wt %. Then, the ion-exchanged water and the dispersant prepared as described above were added to a predetermined amount of bismuth ruthenium oxide powder, and mixed to prepare a catalyst dispersion. Next, the obtained catalyst dispersion was fed into a disintegration chamber from a feeding port of the disintegration chamber of a wet bead mill apparatus (Ashizawa Finetech Ltd., Labostar Mini DMS65) at a flow rate of 200 mL/min by a pump. Beads made of partially stabilized zirconia (PSZ) having a diameter of 0.1 mm were put in the disintegration chamber in advance. Then, a stirring mechanism in the disintegration chamber was driven at a peripheral speed of 8 m/s to perform the disintegration treatment on the clumps of the bismuth ruthenium oxide particles for 9 minutes. After the disintegration treatment of a first stage was performed in this manner, the catalyst dispersion rejected from a rejection port of the disintegration chamber was fed again into the disintegration chamber from the feeding port of the disintegration chamber to perform the disintegration treatment of a second stage. In this way, the procedure including the catalyst dispersion feeding, the disintegration treatment, and the rejection was set as one pass, and this one pass was repeated five times in total (five passes). Thereafter, the catalyst dispersion was concentrated by being kept in an atmosphere at 60° C. for 12 hours. The solid content ratio of the concentrated catalyst dispersion was 27 wt %.

### (2) Production of Air Electrode Mixture Slurry

As the conductive material, a graphite powder which is an aggregate of graphite particles was prepared. The graphite particles had an average particle size (D50) of 3.3 μm as measured by a laser diffraction/scattering type particle size distribution measuring device. Further, a manganese dioxide powder (manufactured by Tosoh Corporation, FMH, average particle size (D50) of 5 μm) which is an aggregate of manganese dioxide particles was prepared. This manganese dioxide powder was heated to 450° C. in an air atmosphere and kept for 7 hours to perform a calcination treatment. Further, a perfluoroethylene propene copolymer (FEP) dispersion (manufactured by Chemours-Mitsui Fluoroproducts Co., Ltd., 120-JRB, average particle size of 0.2 μm), hydroxypropyl cellulose (HPC) as a viscosity modifier, and ion-exchanged water were prepared.

The concentrated catalyst dispersion obtained as described above was prepared by weighing so that the bismuth ruthenium oxide powder (oxygen catalyst) contained therein was 50 parts by weight, and to this catalyst dispersion were added 30 parts by weight of the graphite powder, 30 parts by weight of the perfluoroethylene propene copolymer (FEP) dispersion in terms of solid content ratio, 1 part by weight of hydroxypropyl cellulose (HPC), 2.5 parts by weight of manganese dioxide powder, and 130 parts by weight of ion-exchanged water, which were prepared as described above, and these were fed into a stirring vessel of a planetary centrifugal mixer, and mixed and stirred by driving the planetary centrifugal mixer. Thus, an air electrode mixture slurry having a solid content ratio of 34.5% was produced.

### (3) Production of Air Electrode

A sheet-shaped foamed nickel (thickness: 1.6 mm, average pore size: 580 μm, basis weight: 575 g/m²) was prepared as an air electrode core. Then, the foamed nickel sheet was rolled and pressed to adjust the thickness to 0.35 mm.

Next, the air electrode mixture slurry obtained as described above was filled into the foamed nickel sheet whose thickness was adjusted. Thereafter, the foamed nickel sheet holding the slurry of the mixture for the air electrode was dried by being kept in an atmosphere at 80° C. for 20 minutes. After the drying treatment, the foamed nickel sheet holding the mixture for the air electrode was rolled and pressed, and compressed to a thickness of 0.20 mm, and then cut to a size of 40 mm in length and 40 mm in width. Thus, an intermediate product of the air electrode was obtained.

Next, the obtained intermediate product was subjected to a heat treatment (calcination treatment). Specifically, the intermediate product was put into an electric furnace for calcination. The calcination treatment conditions included heating to a calcination temperature of 250° C. in an air atmosphere and keeping at this temperature for 13 minutes. Thus, the air electrode 16 was obtained.

The weight of the obtained air electrode 16 was measured. The result was defined as an air electrode weight. Then, the weight of the foamed nickel measured in advance was subtracted from the air electrode weight to calculate the weight of the dried air electrode mixture held in the foamed nickel. Further, the amount of the bismuth ruthenium oxide (oxygen catalyst) was determined from the weight ratio of the bismuth ruthenium oxide added to the air electrode mixture. As a result, the amount of the bismuth ruthenium oxide in the air electrode according to Example 1 was 0.12 g.

### (4) Production of Negative Electrode

Metal materials of Nd, Mg, Ni, and Al were mixed at a predetermined molar ratio, then put into a high-frequency induction melting furnace, and melted in an argon gas atmosphere, and the obtained molten metal was poured into a mold and cooled to room temperature of 25° C. to produce an ingot.

Next, the ingot was kept in an argon gas atmosphere at a temperature of 1000° C. for 10 hours to perform a heat treatment, and then cooled to room temperature of 25° C. After cooling, the ingot was mechanically pulverized in an argon gas atmosphere to obtain a rare earth-Mg—Ni-based hydrogen storage alloy powder. The volume average particle size (MV) of the obtained rare earth-Mg—Ni-based hydrogen storage alloy powder was measured by a laser diffraction/scattering type particle size distribution measuring device. As a result, the volume average particle size (MV) was 60 μm.

The composition of the hydrogen storage alloy powder was analyzed by inductively coupled plasma optical emission spectroscopy (ICP-AES) and found to be Nd_{0.89}Mg_{0.11}Ni_{3.33}Al_{0.17}.

To 100 parts by weight of the obtained hydrogen storage alloy powder, 0.2 parts by weight of sodium polyphosphate powder, 0.04 parts by weight of carboxymethyl cellulose powder, 0.3 parts by weight of carbon black powder, and 22.4 parts by weight of water were added and kneaded in an environment of 25° C. to prepare a negative electrode mixture paste.

The negative electrode mixture paste was filled in a foamed nickel sheet having an areal density (basis weight) of 300 g/m² and a thickness of 1.7 m. Then, the negative electrode mixture paste was dried to obtain a foamed nickel sheet filled with the negative electrode mixture. The sheet obtained was pressed to increase the alloy content per unit volume, and then cut to a size of 40 mm in length and 40 mm in width. Thus, the negative electrode 12 was obtained. The thickness of the negative electrode 12 was 0.75 mm. A negative electrode capacity calculated from the electrochemical alloy capacity was 2500 mAh.

### (5) Production of Air Hydrogen Secondary Battery

The obtained air electrode 16 and negative electrode 12 were stacked with the separator 14 sandwiched therebetween to produce the electrode group 10. The separator 14 used in producing the electrode group 10 is formed of a composite having a three-layer structure in which one sheet of microporous membrane was sandwiched between two sheets of nonwoven fabrics.

The microporous membrane is a polymer film made of polypropylene and have a large number of pores. The average pore size of the pores is 36 nm. The microporous membrane has a thickness of 25 μm and a porosity of 41%. The microporous membrane is subjected to a hydrophilic treatment. Specifically, the hydrophilic treatment is performed by immersing the microporous membrane in an aqueous solution containing a surfactant.

As the nonwoven fabric, a polypropylene fiber nonwoven fabric having a sulfone group was used, and the thickness thereof was 0.2 mm (basis weight: 100 g/m²).

Next, the container body 6 made of an acrylic resin was prepared, and the electrode group 10 was housed in the container body 6. At this time, a foamed nickel sheet as the adjustment member 36 was disposed on the bottom wall 18 of the container body 6, and the electrode group 10 was placed on the adjustment member 36. Here, the foamed nickel sheet as the adjustment member 36 has a thickness of 1 mm and has a square shape with a length of 40 mm and a width of 40 mm.

Next, the water-repellent ventilation member 40 was disposed on the electrode group (on the air electrode 16). Here, the water-repellent ventilation member 40 is formed by combining the PTFE porous membrane 42 having a length of 45 mm, a width of 45 mm, and a thickness of 0.1 mm and the nonwoven fabric diffusion sheet 44 having a length of 40 mm, a width of 40 mm, and a thickness of 0.2 mm.

Next, the lid 8 made of an acrylic resin was placed on the container body 6 so as to close the opening 22. At this time, an area including the ventilation passage 30, the inlet ventilation hole 32, and the outlet ventilation hole 34 in the inner surface 28 of the lid 8 was brought into close contact with the water-repellent ventilation member 40 so that the entire area was covered with the water-repellent ventilation member 40. Here, the ventilation passage 30 has a single serpentine shape as a whole. A cross section of the ventilation passage 30 was rectangular, with a vertical dimension of the rectangle being 1 mm and a horizontal dimension being 1 mm. The ventilation passage 30 is open on the water-repellent ventilation member 40 side.

With respect to the container 4 formed by combining the container body 6 and the lid 8, the peripheral edge portions 46 and 48 are sandwiched from above and below by the coupling tools 50 and 52, respectively. A resin packing (not illustrated) is disposed at a contact portion between the container body 6 and the lid 8 to prevent leakage of the alkaline electrolyte solution.

Next, a KOH aqueous solution with a concentration of 5 mol/L was injected into the electrolyte solution storage portion 80 as the alkaline electrolyte solution 82.

In the manner described above, the battery 2 as illustrated in FIG. 1 was produced.

The air electrode lead 54 is electrically connected to the air electrode 16, and the negative electrode lead 56 is electrically connected to the negative electrode 12, and the air electrode lead 54 and the negative electrode lead 56 extend appropriately from the lead wire withdrawal openings 24 and 26 to the outside of the container 4 while the airtightness and liquid-tightness of the container 4 are maintained. In addition, the air electrode terminal 58 is attached to the tip of the air electrode lead 54, and the negative electrode terminal 60 is attached to the tip of the negative electrode lead 56.

### Example 2

An air hydrogen secondary battery was produced in the same manner as in Example 1, except that in producing the air electrode mixture slurry, the concentrated catalyst dispersion was prepared by weighing so that the bismuth ruthenium oxide powder (oxygen catalyst) contained therein was 25 parts by weight, and that the manganese dioxide powder was 25 parts by weight. The amount of the bismuth ruthenium oxide in an air electrode according to Example 2 was 0.06 g.

### Comparative Example 1

An air hydrogen secondary battery was produced in the same manner as in Example 1, except that the manganese dioxide powder was not added in producing the air electrode mixture slurry. The amount of the bismuth ruthenium oxide in an air electrode according to Comparative example 1 was 0.11 g.

### Comparative Example 2

An air hydrogen secondary battery was produced in the same manner as in Example 1, except that two sheets of polypropylene fiber nonwoven fabrics (thickness: 0.2 mm, basis weight: 100 g/m²) were stacked and used as the separator without using the microporous membrane. The amount of the bismuth ruthenium oxide in an air electrode according to Comparative Example 2 was 0.11 g.

### Comparative Example 3

An air hydrogen secondary battery was produced in the same manner as in Example 1, except that the manganese dioxide powder was not added in producing the air electrode mixture slurry, and two sheets of polypropylene fiber nonwoven fabrics (thickness: 0.2 mm, basis weight: 100 g/m²) were stacked and used as the separator without using the microporous membrane. The amount of the bismuth ruthenium oxide in an air electrode according to Comparative Example 3 was 0.10 g.

### 2. Evaluation of Battery

### (1) Evaluation of Battery Characteristics

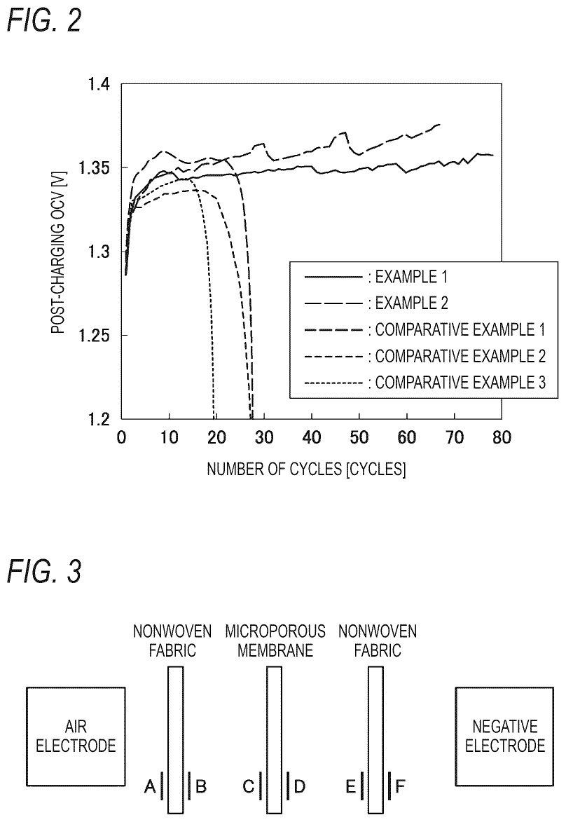

For the air hydrogen secondary batteries according to Examples 1 and 2 and Comparative Examples 1 to 3, 2 Ah corresponding to 80% of the negative electrode capacity was set to 1 It, and charging at 0.1 It for 10 hours and discharging at 0.2 It (discharge cut-off voltage E.V.=0.4 V) were repeated. During this process, a rest of 10 minutes was provided between charging and discharging and between discharging and charging. Then, an open circuit voltage (OCV) 10 minutes after the start of the rest was measured. At this time, an open circuit voltage during the rest between charging and discharging was defined as post-charging OCV, and an open circuit voltage during the rest between discharging and charging was defined as post-discharging OCV. Then, a time point at which the post-charging OCV value fell below 1.2 V was defined as a time point at which an internal short circuit occurred, and the number of cycles at that time was shown as the number of cycles at the time of occurrence of a short circuit in Table 1. Further, a graph illustrating a relation between the post-charging OCV value and the number of cycles was illustrated in FIG. 2.

In the above charging and discharging operations, regardless of charging and discharging, air was introduced through the inlet ventilation hole 32 and discharged through the outlet ventilation hole 34, and the ventilation passage 30 was continuously supplied with an air (CO₂ with a concentration of about 100 ppm) bubbled through the KOH aqueous solution at a rate of 33 mL/min.

TABLE 1

| | | Amount of | | |
|---|---|---|---|---|
| | | MnO₂ | | |
| | | relative | | Number of |
| | Mn | to oxygen | Presence of | cycles until |
| | compound | catalyst | microporous | short circuit |
| | added | [wt %] | membrane | occurs [cycles] |
| Example 1 | Yes | 5 | Yes | No short |
| | | | | circuit until 78 |
| Example 2 | Yes | 100 | Yes | No short |
| | | | | circuit until 67 |
| Comparative | No | — | Yes | 29 |
| example 1 | | | | |
| Comparative | Yes | 5 | No | 28 |
| example 2 | | | | |
| Comparative | No | — | No | 20 |
| example 3 | | | | |

### (2) Elemental Analysis

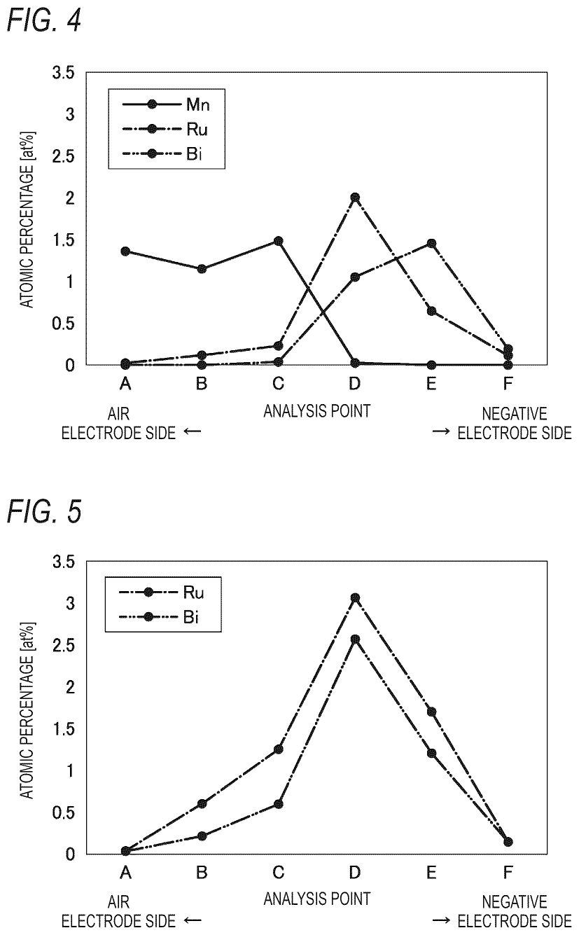

After the above evaluation of battery characteristics, the air hydrogen secondary batteries according to Example 1 and Comparative Example 1 were disassembled and the separators were removed. The removed separators were immersed in ion-exchanged water, and the ion-exchanged water was replaced with new ion-exchanged water every 30 minutes, and this operation was repeated seven times to wash the separators. The washed separators were dried and then disassembled into the air electrode side nonwoven fabric, the microporous membrane, and the negative electrode side nonwoven fabric. Then, the air electrode side nonwoven fabric, the microporous membrane, and the negative electrode side nonwoven fabric were subjected to surface observation with a scanning electron microscope and elemental analysis with energy dispersive X-ray spectroscopy, that is, so-called SEM/EDS was used to analyze the distribution and concentration of bismuth, ruthenium, and manganese in the separators. Specifically, as illustrated in FIG. 3, elemental analysis was performed at a total of six points, that is, an analysis point A on an air electrode side surface of the air electrode side nonwoven fabric positioned on the air electrode side, an analysis point B on a negative electrode side surface of the air electrode side nonwoven fabric, an analysis point C on an air electrode side surface of the microporous membrane, an analysis point D on a negative electrode side surface of the microporous membrane, an analysis point E on an air electrode side surface of the negative electrode side nonwoven fabric positioned on the negative electrode side, and an analysis point F on a negative electrode side surface of the negative electrode side nonwoven fabric. For the analysis, a scanning electron microscope (JSM-6510 manufactured by JEOL Ltd.) equipped with an energy dispersive X-ray analyzer (EDS) was used. At this time, composition analysis was performed by full mapping of two fields of view at an accelerating voltage of 15 kV, a measurement magnification of 500 times, and an accumulation count of 20 times. The ratio of bismuth, ruthenium, and manganese amounts in the bulk was calculated using the average of the values measured in the two fields of view. The atomic percentages [at %] of Mn, Ru, and Bi were determined assuming that the total of Mn, Bi, Ru, and other elements (C, O, Al, Si, K, Ni, Nd, and Au) was 100%. The average composition analysis results of the samples measured at the respective measurement points were illustrated in FIGS. 4 and 5.

### (3) Discussion

From Table 1 and FIG. 2, in Example 1, no decrease in the post-charging OCV value was observed until the number of cycles reached 78. In Example 2, no decrease in the post-charging OCV value was observed until the number of cycles reached 67. Therefore, it is considered that no internal short circuit occurred in Example 1 and Example 2.

Meanwhile, in Comparative Example 1, the number of cycles was 29, in Comparative Example 2, the number of cycles was 28, and in Comparative Example 3, the number of cycles was 20, with the post-charging OCV value falling below 1.2 V. Therefore, it is considered that internal short circuits occurred in Comparative Examples 1 to 3 at the above numbers of cycle counts. From these results, when Comparative Example 2 in which the Mn compound was added but only the nonwoven fabric was used showed a change in resistance to internal short circuits of only about 8 cycles compared with Comparative Example 3 in which the Mn compound was not added, and when Comparative Example 3 in which the Mn compound was not added and only the nonwoven fabric was used was compared with Comparative Example 1 in which the microporous membrane was used, the short circuit prevension effect was about the same.

From the above results, it can be seen that the effect of preventing the internal short circuit is remarkably improved by adding the Mn compound and using the microporous membrane.

From FIGS. 4 and 5, in Example 1, Mn was detected in large amounts on the air electrode side (portion C) of the microporous membrane and the air electrode side nonwoven fabric (portions A and B), while Ru and Bi were found in large amounts on the negative electrode side (portion D) of the microporous membrane, and were hardly detected from the air electrode side (portion C) of the microporous membrane to the side where the air electrode is positioned. This is considered to be because the pores on the air electrode side of the microporous membrane are clogged with Mn, and Bi and Ru are less likely to reach the air electrode side.

Meanwhile, although the microporous membrane was used also in Comparative Example 1, the amounts of Bi and Ru detected on the air electrode side (portion C) and the negative electrode side (portion D) of the microporous membrane were larger than those in Example 1. This is considered to be because the Mn compound is not added in Comparative Example 1, and thus the effect of Mn for preventing the penetration of dendrites is not exhibited.

It is considered that by adding the Mn compound to the air electrode mixture and using the separator including the microporous membrane as in Example 1, Mn is dissolved and precipitated on the microporous membrane, preventing dendrites of Bi or Ru derived from the by-products from easily penetrating through the separator to the air electrode side, thereby preventing the occurrence of internal short circuits and extending the cycle life.

The present invention is not limited to the embodiments described above and examples, and various modifications can be made. For example, the negative electrode metal is not limited to the hydrogen storage alloy, and the present invention can be applied to an air secondary battery in which the negative electrode metal is changed to Li, Zn, Al, Mg, or the like.

### REFERENCE SIGNS LIST

2 battery (air hydrogen secondary battery)
4 container
6 container body
8 lid
10 electrode group
12 negative electrode
14 separator
16 air electrode (positive electrode)
30 ventilation passage
40 water-repellent ventilation member

1. An air secondary battery comprising:
a container; and
an electrode group housed in the container together with an alkaline electrolyte solution, wherein
the electrode group includes an air electrode and a negative electrode stacked with a separator interposed therebetween,
the air electrode includes a core and an air electrode mixture,
the air electrode mixture contains an oxygen catalyst and a manganese compound, and
the separator is a composite formed by laminating a microporous membrane and a nonwoven fabric in a thickness direction.

2. The air secondary battery according to claim 1, wherein the oxygen catalyst contains bismuth ruthenium oxide.

3. The air secondary battery according to claim 2, wherein the manganese compound is contained in an amount of 5 wt % or more and 150 wt % or less with respect to the bismuth ruthenium oxide.

4. The air secondary battery according to claim 1, wherein the composite has a three-layer structure formed by sandwiching one sheet of the microporous membrane between two sheets of the nonwoven fabrics.

5. The air secondary battery according to claim 1, wherein the air electrode mixture further contains graphite and a fluororesin.

6. The air secondary battery according to claim 1, wherein the negative electrode contains a hydrogen storage alloy.

7. The air secondary battery according to claim 2, wherein the air electrode mixture further contains graphite and a fluororesin.

8. The air secondary battery according to claim 3, wherein the air electrode mixture further contains graphite and a fluororesin.

9. The air secondary battery according to claim 4, wherein the air electrode mixture further contains graphite and a fluororesin.
